(19) United States
(12) Patent Application Publication
(10) Pub. No.: US 2022/0315495 A1
(43) Pub. Date: Oct. 6, 2022

(54) MATERIALS AND PROCESSES FOR MANUFACTURING CARBON COMPOSITE ARTICLES BY THREE-DIMENSIONAL PRINTING

(71) Applicant: A&S Business Group Pty Ltd, Newport, Victoria (AU)

(72) Inventor: Saeed DADVAR, Newport, Victoria (AU)

(73) Assignee: A&S Business Group Pty Ltd, Newport, Victoria (AU)

(21) Appl. No.: 17/616,471

(22) PCT Filed: Jun. 4, 2020
(86) PCT No.: PCT/AU2020/000045

§ 371 Date: Dec. 3, 2021

(30) Foreign Application Priority Data
Jun. 4, 2019 (AU) 2019901938

(51) Int. Cl. C04B 35/83; B33Y 10/00; B33Y 40/20; B29C 64/165; B29C 64/30; C04B 35/64; C04B 35/628

(52) U.S. Cl. CPC C04B 35/83; B33Y 10/00; B33Y 40/20; B29C 64/165; B29C 64/30; C04B 35/64; C04B 35/62886; C04B 35/62873; B29K 2401/00

(57) ABSTRACT

The present invention describes various aspects of an inexpensive, renewable and sustainable particulate material system which is basically composed of one or more carbon precursor materials and other powder-based constituents. There is also an in-detail description of the composition of the preferred particulate material system and steps involved in manufacturing high-performance carbon composite articles using commercial binder jetting powder-based 3D printers. The preferred particulate material system composition of the present invention can be equal in performance to typical binder jetting 3D printing powders but much less expensive.

### RELATED APPLICATION

The present application claims priority from Australian Provisional Patent Application No. 2019901938, the entire contents of which are incorporated herein by reference.

### FIELD OF THE INVENTION

The present invention relates generally to the field of three-dimensional (3D) printing, also known as additive manufacturing, and more particularly to manufacturing carbon composite articles by binder jetting powder-based 3D printing.

### BACKGROUND OF THE INVENTION

Carbon composite articles are durable, strong and lightweight and have applications across a wide range of industries, including aerospace, automotive, medical, sport and defence. However, despite the outstanding properties of carbon composite articles, their high cost has limited their application to products where performance is generally more important than price. This is largely due to the use of expensive petroleum-based raw materials and a very complicated and laborious manufacturing process, which contributes to the high cost of carbon composite articles.

Conventionally, carbon composite articles are made by molding the unformed combination of a matrix and carbon fibers/powders into the desired shape prior to and during the curing process. This conventional manufacturing process, which is not related to 3D printing, is very expensive due to the high cost of (1) carbon fibers/powders made from petroleum-based precursor materials such as polyacrylonitrile and (2) molds or tools made of robust metals that can withstand repeated molding cycles whilst maintaining good surface finish and dimensional accuracy. Polyacrylonitrile contributes to about half of the price of carbon fibers/powders and is synthesized using toxic and carcinogenic chemicals whose price fluctuates with the price of crude oil. Also, tooling costs and complexity increase with an increase in the performance requirements, surface quality requirements and/or the number of carbon composite articles that are to be produced. In addition, conventional manufacturing techniques offer limited design flexibilities for making carbon composite articles with complex geometries.

3D printing refers to a group of additive manufacturing techniques that make three-dimensional solid objects from a computer-assisted design (CAD) model by selectively depositing successive layers of material one upon another. 3D printing technologies were initially developed as a tool for rapid prototyping in the 1980's, enabling engineers and designers to prototype their design ideas or do a proof-of-concept work. However, in more recent times, such technologies have developed to the point that they now offer new ways of transforming traditional manufacturing methods, thereby significantly changing the manufacturing industry.

Unlike conventional carbon composite manufacturing techniques which are wasteful, expensive, laborious and time-consuming, 3D printing technologies offer great advantages of design flexibility, lower energy consumption and reduced lead time. Additionally, 3D printing technologies provide an ability for manufacturers to effectively control the entire manufacturing process. Thus, manufacturers are able to predict and optimize the time and cost required for the production of carbon composite articles without the need to worry about any changes that might be implemented during product development.

In recent times, there has been a focus on employing 3D printing technologies in the development of material systems for manufacturing carbon composite articles. Fused Filament Fabrication (FFF) and Selective Laser Sintering (SLS) are two of widely used 3D printing technologies in which matrix and reinforcing components are initially blended to form a reinforced feedstock in the form of a filament or a powder which is then fed into 3D printing apparatus for manufacturing carbon composite articles.

Whilst the mechanical properties of 3D printed carbon composite articles produced by FFF or SLS techniques are generally an order of magnitude higher than that of the typical 3D printed articles with no reinforcing components, they are significantly inferior to carbon composite articles made by conventional manufacturing techniques. In both of the FFF and SLS techniques, the presence of inter-bead or inter-particle voids, gas bubbles and pull-out of short carbon fibers from the matrix before fiber breakage, are reported as the main reasons for the lower mechanical properties of the 3D printed carbon composite articles. In the FFF technique, whilst the use of continuous carbon fiber reinforced filaments has addressed the fiber pull-out issue, there are still large inter-bead voids and many resin-rich areas in the resulting 3D printed carbon composite articles. In the SLS technique, there are limitations associated with the use of longer carbon fibers in the powder form since a standard particle size and morphology is required for this type of powder-based 3D printing technology.

Even though the FFF and SLS techniques have addressed some of the challenges in conventional carbon composite manufacturing techniques in terms of design flexibility and ease of implementations, these two widely used 3D printing technologies are still heavily reliant on expensive petroleum-based material systems. Accordingly, there exists a need for an alternative 3D printing technology that is affordable, renewable, sustainable and easily configurable for low-cost manufacturing of carbon composite articles by 3D printing technologies.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

The present invention describes various aspects of an inexpensive, renewable and sustainable particulate material system which is basically composed of one or more carbon precursor materials and other powder-based constituents. There is also an in-detail description of the composition of the preferred particulate material system and steps involved in manufacturing high-performance carbon composite articles using commercial binder jetting powder-based 3D printers. The preferred particulate material system composition of the present invention can be equal in performance to typical binder jetting 3D printing powders but much less expensive.

The present invention allows conventional binder jetting powder-based 3D printing technology to be used for manufacturing carbon composite articles at low cost and for wide ranges and scales of applications. The cost to manufacture carbon composite articles according to the invention is still a fraction of the typical cost of conventional carbon composite manufacturing techniques even with the inclusion of pre- and/or post-processing operations in the methods.

In a first aspect, there is provided a method for manufacturing a carbon composite article by binder jetting powder-based 3D printing technology comprising steps of:

(a) preparing a particulate material system;

(b) introducing the particulate material system into the binder jetting powder-based 3D printer and producing a precursor article;

(c) converting the precursor article into a carbon preform;

(d) infiltrating the carbon preform with a low-viscosity liquid-based material; and

(e) curing or polymerizing the infiltrated carbon preform to form the carbon composite article.

An aspect of the present invention is to use conventional binder jetting powder-based 3D printing technology to produce carbon composite articles that have a high strength-to-weight ratio and a high stiffness-to-weight ratio. That said, the resulting carbon composite articles can be considered in many industries for the fabrication of specialized carbon composite products.

Accordingly, an aspect of the invention is to provide an alternative material system for use in commercial binder jetting powder-based 3D printers for the production of high-end, strong and durable carbon composite articles.

Another aspect of the invention is to reduce the cost of manufacturing carbon composite articles by using the preferred particulate material system in commercial binder jetting powder-based 3D printers.

Still another aspect of the invention is to provide methods that combine binder jetting 3D printing process with pre- and/or post-processing operations for the production of 3D printed carbon composite articles that possess excellent structural and mechanical characteristics with broad use-cases across many industries.

Further aspects of the invention will be brought out in the following sections of the specification, wherein the detailed description is for the purpose of fully disclosing preferred embodiments of the invention without placing limitations thereon.

### BRIEF DESCRIPTION OF THE DRAWINGS

The features and advantages of the present invention will be more fully understood with reference to the attached drawings and figures (‘FIG.’ or ‘FIGS.’ herein). All drawings and figures are for illustration purposes only without limiting any aspects of the invention.

FIG. 1 illustrates a schematic of an embodiment of the present invention representing the six steps for manufacturing carbon composite articles from the preferred particulate material system using binder jetting powder-based 3D printing process coupled with pre- and/or post-processing operations, i.e. intermediate impregnation, heat treatments and resin infiltration;

FIG. 2 illustrates a preferred carbon preform (201) produced from a particulate material system with less than about 2.38 parts by weight of dextrin powder as specified in the present invention and a disintegrated carbon preform (202) produced from a particulate material system with more than about 2.38 parts by weight of dextrin powder which is not desirable for the purpose of the present invention;

FIG. 3 illustrates a schematic of a typical binder jetting powder-based 3D printing process and its components;

FIG. 4 illustrates CAD models of a standard test plate designed to assess minimum feature size of the 3D printed articles produced from the particulate material systems described in the embodiments of the present invention.

FIG. 5 illustrates steps taken in an image processing approach to calculate the total area of holes on each 2D image as an indicative measure of the minimum feature size of each 3D printed standard test plate, meaning the bigger the total area of holes, the smaller the minimum feature size.

### DETAILED DESCRIPTION OF THE PREFERRED EMBODIMENTS

The present invention will be described below in relation to one or more preferred embodiments for performing the invention. It will be appreciated that the present invention as described herein does not in any way limit the scope of the present invention as set forth in the claims.

Unless otherwise indicated, all numerical values or quantities expressing conditions, concentrations, contents, dimensions and so forth used herein or in the claims are to be construed as meaning the normal measuring and/or fabrication limitations related to the value being modified in all instances by the term ‘about’. Accordingly, unless indicated to the contrary, the numerical parameters set forth in the following specification and attached claims are approximations that may vary depending at least upon a specific analytical technique. It is to be construed that whenever a range of values is described herein or in the claims that the range includes the end points and every point therebetween as if each and every such point had been expressly described.

The term ‘carbon precursor’ used herein or in the claims simply refers to the capability to be ultimately converted to a carbon material. It is noted that the disclosed particulate material systems of the present invention are precursors to carbon precursor materials, which themselves are precursors to carbon materials. As intended herein, a ‘resin’ means a composition capable of being polymerized or cured, further polymerized or cured or crosslinked. Resins may include monomers, oligomers, pre-polymers, or mixtures thereof.

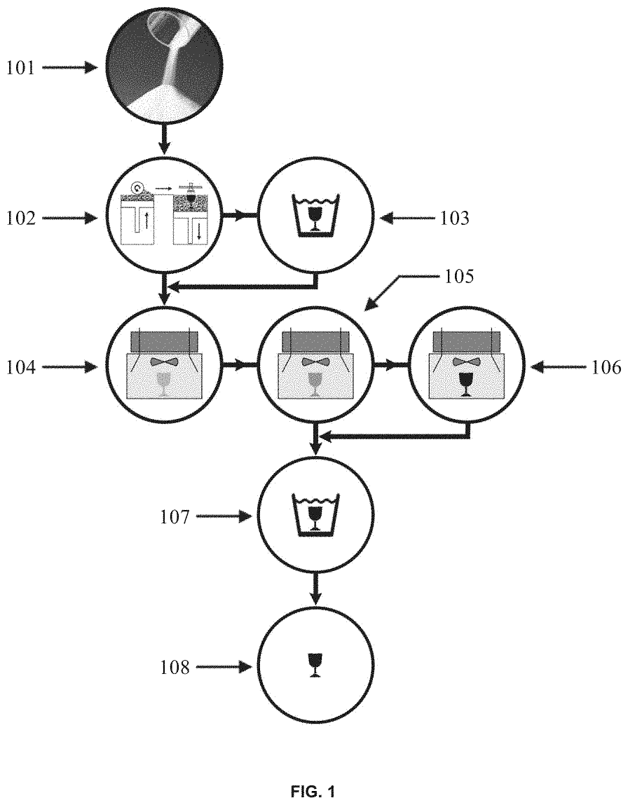

Referring to FIG. 1, an embodiment of the present invention for manufacturing carbon composite articles by binder jetting powder-based 3D printing technology is depicted. The method generally consists of six main steps as follow: (101) preparation of the preferred particulate material system which is basically composed of one or more carbon precursor materials and other powder-based constituents; (102) 3D printing of precursor articles using the preferred particulate material system; (103) optional impregnation of the 3D printed precursor articles using a polymer solution as an impregnant; (104, 105, 106) thermal conversion of the impregnated or not-impregnated 3D printed precursor articles into carbon preforms; (107) resin infiltration of the carbon preforms by means of capillary action under atmospheric condition or applying vacuum or pressure; (108) curing the resin infiltrated carbon preforms at room temperature or at a curing temperature depending on the class of resin used during resin infiltration.

### Step 1—Particulate Material System Preparation

Referring to FIG. 1, the preferred particulate material system 101 is prepared for use in the commercial binder jetting powder-based 3D printers. The individual materials that are used to create the particulate material system, and the particulate material system itself, should be in powder form that is suitable for use in binder jetting powder-based 3D printers. With respect to the average particle size, it is preferable that the average particle size of the particulate material system be less than about 125 μm and greater than 10 μm. More preferably in some embodiments, it ranges from about 10 μm to about 115 μm. In other embodiments, it preferably ranges from about 10 μm to 90 μm. In some embodiments, the particle size distribution preferably follows a log-normal particle size distribution model where the distribution curve is asymmetric and negatively skewed over the x-axis. The particle size distribution exhibits a D₅₀ of about 35 μm, D₁₀ of about 10 μm, and D₉₀ of about 110 μm. The particle size distribution of the particulate material system should contain no particles having a size which is greater than the layer thickness that is to be used in binder jetting powder-based 3D printing process, and more preferably no greater than half the layer thickness that is to be used in binder jetting powder-based 3D printing process.

The term ‘D₅₀’ means that 50% of the particles in the particulate material system or its powder-based constituents are smaller than the reported value. The ‘D₅₀’ value was measured using a laser diffraction particle size measurement device together with its associated particle size analysis software from Malvern Instruments Pty. Ltd., UK.

Morphology and shape of particles are also important variables for the purpose of the present invention. Particulate material systems with regular particles have a good flowability but a low packing density, whereas those with irregular particles have a low flowability but a good packing density. In the present invention, the particulate material system is preferably composed of a combination of both irregular and regular particles.

The preferred particulate material system of the present invention is preferably composed of three constituents: (a) a carbon precursor material, (b) an adhesive material and (c) a capillary action retarder.

In various embodiments, the carbon precursor material (a) may be selected from a group of renewable materials consisting of naturally occurring biopolymers such as polysaccharides (e.g. cellulose & hemicellulose) and proteins (e.g. silk & wool). The carbon precursor material (a) may also be selected from naturally occurring phenolic compounds such as lignin and its derivatives which can be obtained from biomass resources such as plants (e.g. bagasse, corn stover & switchgrass) and woody resources (e.g. pine, eucalyptus & poplar). Combinations of carbon precursor materials may also be used in some variations.

In various embodiments, the adhesive material (b) may be selected from a group of water-soluble materials consisting of low-molecular-weight polysaccharides such as dextrin, maltodextrin, dextran, starch, sucrose and glucose. Combinations of adhesive materials may also be used in some variations. The adhesive material (b) should be fine enough to evenly distribute in the particulate material system and can be quickly dissolved or activated by a liquid binder. However, the adhesive material (b) should not be so fine as to cause ‘caking’—an undesirable phenomenon wherein the undissolved adhesive material (b) adheres to the surface of the 3D printed article and leads to poor surface finish or printing resolution.

In various embodiments, the capillary action retarder (c) may be selected from a group of cellulose derivatives consisting of hydroxypropyl methylcellulose, hydroxypropyl cellulose, hydroxyethyl cellulose, methyl cellulose and sodium carboxymethyl cellulose. Combinations of capillary action retarders may also be used in some variations. The capillary action retarder (c) increases the viscosity of the liquid binder during 3D printing process and minimizes the diffusion of the liquid binder into the surrounding powder, leading to a good surface finish and a good dimensional accuracy on the resultant 3D printed article.

The composition of the preferred particulate material system of the present invention may comprise about 2.38 to about 3.14 parts by weight of carbon precursor material (a), about zero to about 2.38 parts by weight of adhesive material (b) and about zero to about 0.24 parts by weight of capillary action retarder (c).

Preferably, the particulate material system of the present invention is composed of cellulose as the carbon precursor material (a) with a carbon content of about 44.21%, dextrin as the adhesive material (b) with a carbon content of about 39.33% and hydroxypropyl methylcellulose as the capillary action retarder (c) with a carbon content of about 67.84%.

Cellulose as the carbon precursor material (a) is preferred because of its abundance and low-cost. In fact, cellulose is the most abundant naturally occurring biopolymer on earth with a total annual production of about 10¹¹ to 10¹² tons. Cellulose can be sourced from a broad range of inexpensive renewable natural resources such as cotton linters, agricultural residues and wood pulps, to name a few.

In the embodiments where dextrin is used as the adhesive material (b), dextrin is sieved through a preferred mesh size of about 200 μm so that large clumps are not added to the particulate material system.

In one embodiment, the preferred particulate material system according to the present invention comprises about 1.45 parts by weight of cellulose powder with a D₅₀ of about 60 μm, about 1.31 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the preferred particulate material system according to the present invention comprises about 0.99 parts by weight of cellulose powder with a D₅₀ of about 60 μm, about 1.77 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the preferred particulate material system according to the present invention comprises about 2.76 parts by weight of cellulose powder with a D₅₀ of about 60 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the preferred particulate material system according to the present invention comprises about 1.25 parts by weight of cellulose powder with a D₅₀ of about 60 μm, about 1.13 parts by weight of cellulose powder with a D₅₀ of about 18 μm, about 2.38 parts by weight of dextrin powder with a D₅₀ of about 39 μm and about 0.24 parts by weight of hydroxypropyl methylcellulose powder with a D₅₀ of about 87 μm.

In another embodiment, the preferred particulate material system according to the present invention comprises about 1.65 parts by weight of cellulose powder with a D₅₀ of about 60 μm, about 1.49 parts by weight of cellulose powder with a D₅₀ of about 18 μm, about 1.62 parts by weight of dextrin powder with a D₅₀ of about 39 μm and about 0.24 parts by weight of hydroxypropyl methylcellulose powder with a D₅₀ of about 87 μm.

In an advantageous embodiment, the preferred particulate material system according to the present invention comprises about 0.86 parts by weight of cellulose powder with a D₅₀ of about 60 μm, about 1.52 parts by weight of cellulose powder with a D₅₀ of about 18 μm, about 2.38 parts by weight of dextrin powder with a D₅₀ of about 39 μm and about 0.24 parts by weight of hydroxypropyl methylcellulose powder with a D₅₀ of about 87 μm.

All the three powder-based constituents of the preferred particulate material system can be added together in a large container and shaken to be mixed, or the container can be placed in a cement mixer or a three-dimensional shaker-mixer and turned or rotated for about 1 to 10 hours, depending on the batch size of the preferred particulate material system, until all the constituents are evenly distributed and mixed.

A spray test method may be used to examine the viability of the particulate material systems. First, a small amount of the particulate material system described in the embodiments is prepared, spread and flattened over a substrate using a flat, smooth tool such as a butter knife. Then, a fine mist of a liquid binder is sprayed over the flattened particulate material system to roughly simulate binder jetting powder-based 3D printing machine and to visually observe the viability of the particulate material system. Formation of a hard crust on the surface after drying proves the fact that the respective particulate material system will work well in the binder jetting powder-based 3D printing machine.

The particular ratio selected for the powder-based constituents of the preferred particulate material systems depends on several factors including powder flowability, powder packing density, source of powder-based constituents, chemistry & characteristics of liquid binder as well as the expected physical and mechanical properties of the 3D printed articles.

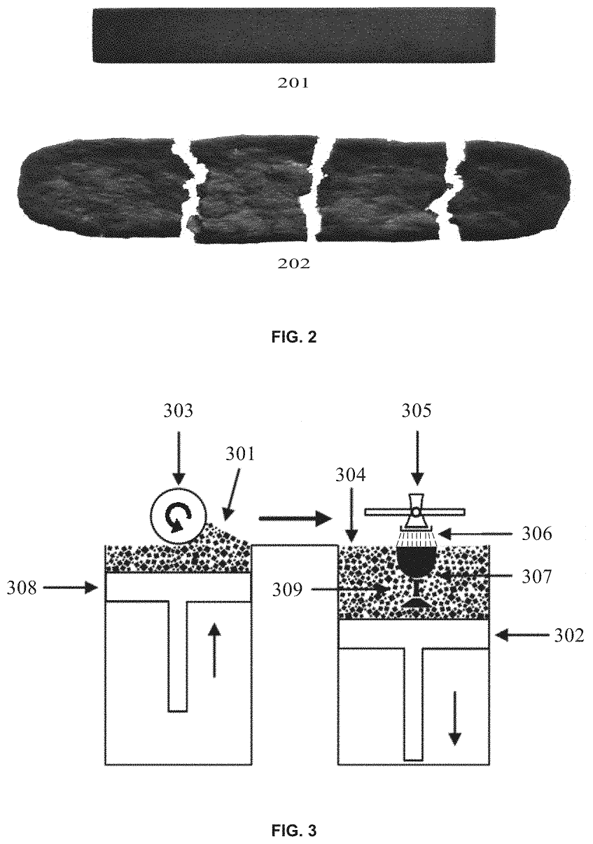

Within the scope of the present invention, it has been found that the amount of cellulose powder with a D₅₀ of about 18 μm should be kept below about 1.77 parts by weight to avoid formation of a cohesive particulate material system with poor flowability. Otherwise, the excessive amount of cellulose powder with a D₅₀ of about 18 μm in the particulate material system promotes van der Waals' interactions in between particles and decreases powder flowability which is not desirable for binder jetting powder-based 3D printing process. Also, the amount of dextrin powder with a D₅₀ of about 39 μm should be kept below about 2.38 parts by weight to avoid disintegration of the 3D printed articles produced from the respective particulate material system during thermal conversion into carbon preforms. Otherwise, the excessive amount of dextrin powder with a D₅₀ of about 39 μm in the particulate material system turns into a fairly large foam-like carbon structure during thermal conversion and results in a catastrophic disintegration of the resultant carbon preforms which is not desirable for the purpose of the present invention. As an example, FIG. 2 illustrates a preferred carbon preform (201) which is produced from a particulate material system with less than about 2.38 parts by weight of dextrin powder and a disintegrated carbon preform (202) which is produced from a particulate material system with more than about 2.38 parts by weight of dextrin powder.

### Step 2—3D Printing of Precursor Articles

Referring to FIG. 3, the preferred commercial binder jetting powder-based 3D printing process desired for the present invention begins with spreading a thin layer of the prepared particulate material system 301 over a build platform 302 using a counter-rotating roller 303 (or its alternatives such as a wiper blade or a hopper depending on the configuration of the commercial binder jetting powder-based 3D printer). This forms a smooth powder bed 304 on which preferably a multiple array ink-jet print head 305 selectively deposits a certain amount of liquid binder 306 with a pre-defined pattern across X- and Y-axis. Typically, the print head 305 moves across the surface of the powder bed 304 along the X-axis and deposits the liquid binder 306 with a pre-defined pattern at pre-defined locations on the powder bed 304. The print head 305 indexes along the Y-axis and makes the next pass along the X-axis to continue deposition of the liquid binder 306 at pre-defined locations on the powder bed 304. Upon contact with the powder bed 304, the liquid binder 306 dissolves or activates the adhesive material (b) in the particulate material system to bind together particles of the carbon precursor material (a) in the particulate material system and transform the selected portion 307 of the powder bed 304 into a solid cross-sectional layer matching the first slice of the article's CAD model. In some variations, upon contact with the powder bed 304, the liquid binder 306 dissolves or activates one or more of the constituents of the particulate material system to bind the particles and transfer the selected portion 307 of the powder bed 304 into a solid cross-sectional layer according to the first slice of the article's CAD model.

Afterwards, while the feeding platform 308 raises along the Z-axis, the build platform 302 lowers along the Z-axis a distance equal to the thickness of the next layer of the particulate material system 301 and again a new layer of the particulate material system 301 spreads over the build platform 302. The binder jetting powder-based 3D printing process repeats with each new layer of the particulate material system 301 adhering to the previous layer below until the whole article is fabricated layer-by-layer and slice-by-slice according to the article's CAD model.

The unbound particulate material system 309 that is not dissolved or activated by the liquid binder 306 during the 3D printing process remains loose around the article being fabricated on the build platform 302 to allow building overhangs, cantilevers and cavities within the article without the need for support structures. Upon completion of the 3D printing process, the fabricated article is left in the powder bed 304 for at least about 24 h at room temperature to achieve a fully consolidated article. In some variations, the 3D printed article may be required to be removed straightaway or be left in the powder bed 304 for a certain period of time at a certain temperature to achieve a fully consolidated article (these variations may be referred to as a post- or in-situ curing process respectively). The 3D printed precursor article is finally taken out from the powder bed 304 and the unbound loose particles on the surface of the article are blown away by a compressed air gun or gently removed by a vacuum brush.

In many embodiments, the amount of the liquid binder 306 to be deposited on the powder bed 304 may be gauged in terms of saturation level which is defined as the ratio of the volume of the deposited liquid binder 306 to the pore volume of the powder bed 304 and generally depends on droplet size of the liquid binder 306, nozzle size of the print head 305, packing density of the powder bed 304 and layer thickness. Generally speaking, saturation level should be high enough so that the deposited liquid binder 306 can completely diffuse into the powder bed 304, dissolve or activate the adhesive material (b) in the particulate material system and bind the upmost layer of the particulate material system 301 to the previous one. Although this ideally leads to a strong high-integrity 3D printed precursor article, high saturation levels would cause oversaturation of the powder bed 304 and therefore the leak of the liquid binder 306 from the impact zones due to capillary effect. This binds the surrounding loose powders around the article being fabricated and ultimately leads to a poor dimensional accuracy and printing resolution. That said, saturation level should be determined in a way that there is a balance between the mechanical and structural integrity, the dimensional accuracy and the resolution of the 3D printed precursor article. Within the scope of the present invention, it was found that saturation level should be preferably kept within the range of 52% to 100% to achieve 3D printed precursor articles with a satisfactory mechanical and structural integrity, minimum feature size, dimensional accuracy and printing resolution.

The thickness of the layer of the particulate material system 301 to be spread over the build platform 302 in each pass is determined according to the thickness of the slices of the article's CAD model generated by the software of the commercial binder jetting powder-based 3D printer and can be set up through the 3D printer's control panel in the software. The thickness of the layer of the particulate material system 301 determines the resolution of the 3D printed precursor article along the Z-axis and should be as thin as possible to achieve a good printing resolution; however, the thinner the layer thickness, the longer it takes to complete 3D printing process. In fact, the number of the layer of the particulate material system 301 that needs to be spread over the build platform 302 to deposit the liquid binder 306 upon to make an article determines the number of ‘powder spreading’ and ‘binder deposition’ cycles and therefore the amount of time to complete the 3D printing process. That said, layer thickness should be determined in a way that there is a balance between the resolution of the 3D printed precursor article and the amount of time to complete the 3D printing process. Within the scope of the present invention, it has been found that layer thickness should be preferably kept within the range of 165 μm to 185 μm to achieve 3D printed precursor articles with a satisfactory dimensional accuracy and printing resolution.

In various embodiments, the liquid binder may be selected from a group of materials consisting of water, glycerol, methyl alcohol, isopropyl alcohol and surfactants. Combinations of the liquid binder materials may also be used in some variations. The preferred commercially available liquid binder for the purpose of the present invention may contain about 85% to about 95% water, about 20% or less coloring pigment, about 1% or less surfactant, about 2% or less preservatives such as sorbic acid salt and about 1% to about 10% glycerol. One typical example of such preferred liquid binder according to the present invention is VisiJet® PXL Clear (3D Systems Inc., USA). The preferred binder jetting powder-based 3D printer for the purpose of the present invention is equipped with thermal ink-jet print head(s) that can successfully deposit most of the above-mentioned group of materials or combinations thereof on the powder bed.

In some variations, the preferred commercial binder jetting powder-based 3D printer is equipped with piezoelectric ink-jet print head(s) that can deposit broader types of liquid binders on the powder bed. Such liquid binders are solvent based and are usually produced by dissolution of an inorganic material such as cellulose acetate, cellulose acetate butyrate, cellulose acetate propionate, poly(vinyl pyrrolidone), poly(vinyl alcohol), poly(ethylene glycol) and poly(acrylic acid) in an organic solvent with a certain viscosity and surface tension matching the specifications of the piezoelectric ink-jet print head(s) used in the binder jetting powder-based 3D printer. In some other variations, a low-viscosity liquid-based resin, monomer, oligomer, polymer, pre-polymer or mixtures thereof may be used as the preferred liquid binder. Upon deposition on the powder bed, such liquid binders may be cured in-situ using a light source or later on after the completion of the 3D printing process in an oven at a curing temperature depending on the chemistry of the liquid binder. Such liquid binders may be selected from a group of materials such as epoxies, acrylics, polyesters, polyurethanes, silicones, phenols and preceramic polymers.

In one embodiment, the 3D printed precursor articles are produced at a saturation level of 76% and a layer thickness of 175 μm from the particulate material system composed of about 1.45 parts by weight of cellulose powder with a D₅₀ of about 60 μm, about 1.31 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 165 μm from the particulate material system composed of about 1.45 parts by weight of cellulose powder with a D₅₀ of about 60 μm, about 1.31 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 185 μm from the particulate material system composed of about 1.45 parts by weight of cellulose powder with a D₅₀ of about 60 μm, about 1.31 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 52% and a layer thickness of 175 μm from the particulate material system composed of about 1.45 parts by weight of cellulose powder with a D₅₀ of about 60 μm, about 1.31 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 100% and a layer thickness of 175 μm from the particulate material system composed of about 1.45 parts by weight of cellulose powder with a D₅₀ of about 60 μm, about 1.31 parts by weight of cellulose powder with a D₅₀ of about 18 μm, about 2.00 parts by weight of dextrin powder with a

D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 175 μm from the particulate material system composed of about 1.25 parts by weight of cellulose powder with a D₅₀ of about 60 μm, about 1.13 parts by weight of cellulose powder with a D₅₀ of about 18 μm, about 2.38 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 175 μm from the particulate material system composed of about 1.65 parts by weight of cellulose powder with a D₅₀ of about 60 μm, about 1.49 parts by weight of cellulose powder with a D₅₀ of about 18 μm, about 1.62 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 175 μm from the particulate material system composed of about 2.76 parts by weight of cellulose powder with a D₅₀ of about 60 μm, about 2.00 parts by weight of dextrin powder with a D₅₀ of about 39 μm and about 0.24 parts by weight of hydroxypropyl methylcellulose powder with a D₅₀ of about 87 μm.

In another embodiment, the 3D printed precursor articles are produced at a saturation level of 76% and a layer thickness of 175 μm from the particulate material system composed of about 0.99 parts by weight of cellulose powder with a D₅₀ of about 60 μm, about 1.77 parts by weight of cellulose powder with a D₅₀ of about 18 μm, about 2.00 parts by weight of dextrin powder with a D₅₀ of about 39 μm and about 0.24 parts by weight of hydroxypropyl methylcellulose powder with a D₅₀ of about 87 μm.

In an advantageous embodiment, the 3D printed precursor articles are produced at a saturation level of 73% and a layer thickness of 181 μm from the particulate material system composed of about 0.86 parts by weight of cellulose powder with a D₅₀ of about 60 μm, about 1.52 parts by weight of cellulose powder with a D₅₀ of about 18 μm, about 2.38 parts by weight of dextrin powder with a D₅₀ of about 39 μm and about 0.24 parts by weight of hydroxypropyl methylcellulose powder with a D₅₀ of about 87 μm.

The Archimedes' principle may be used to obtain the true density of the 3D printed articles. The Archimedes' principle states that the apparent loss in weight of a body immersed in a fluid is equal to the weight of the displaced fluid. According to the Archimedes' principle, the 3D printed article is first vacuum dried at 80° C. for 24 h and weighed in air using a digital balance with 0.0001 g precision. Subsequently, the weight of the 3D printed article is measured in a known density liquid and used in conjunction with its weight in air to calculate the true density of the 3D printed article using Equation (1), where W_{dry} is the weight of the 3D printed article in air and W_{wet} is the weight of the fluid displaced by the 3D printed article submerged in acetone, as a known density liquid (ρ_{liquid}) with a true density of 0.791 g/cm³.

$${ρ}_{t r u e} = \frac{{W}_{d r y} \times {ρ}_{l i q u i d}}{{W}_{d r y} - {W}_{w e t}} \qquad ( 1 )$$

Apparent porosity or pore volume fraction (VFₚₒᵣₑ) of the 3D printed articles may be calculated using Equation (2), in which ρ_{bulk} and ρₜᵣᵤₑ are the bulk and true densities of the 3D printed article. The bulk density of the 3D printed articles can be determined from their dry weight divided by their exterior volume with pores inclusive.

$${VF}_{pore} = ( 1 - \frac{{ρ}_{bulk}}{{ρ}_{t r u e}} ) \times 100 \qquad ( 2 )$$

In various embodiments, the 3D printed precursor articles produced from the particulate material systems described above using a commercial binder jetting powder-based 3D printer preferably have a true density of about 1.30±0.02 g/cm³, particularly preferably about 1.40±0.02 g/cm³ and most preferably about 1.50±0.02 g/cm³. The said 3D printed precursor articles preferably have an apparent porosity of about 74.50±0.84%, particularly preferably about 71.92±0.37% and most preferably about 69.50±0.22%.

In an advantageous embodiment, the 3D printed precursor articles produced from the particulate material systems described above using a commercial binder jetting powder-based 3D printer preferably have a true density of about 1.49±0.03 g/cm³. The said 3D printed precursor articles preferably have an apparent porosity of about 68.67±0.93%.

X-ray computed tomography (CT) or other similar non-destructive techniques may be used in order to assess microstructure of the 3D printed articles in terms of pore connectivity and surface area per unit volume. Pore connectivity is defined as the volume of the largest connected pore phase divided by the total volume of the pore phase within the microstructure of the 3D printed article. Surface area per unit volume, referred to as specific surface area herein, is defined as the total surface area of the solid phase divided by the total volume of the solid phase within the microstructure of the 3D printed article. These microstructural characteristics of the 3D printed articles may be obtained through a series of image processing operations on the acquired X-ray CT data by Avizo Lite 9.0.1 (FEI Technologies Inc., USA).

In various embodiments, the 3D printed precursor articles produced from the particulate material systems described above using a commercial binder jetting powder-based 3D printer preferably have a pore connectivity of about 99.35±0.02%, particularly preferably about 99.70±0.04% and most preferably about 99.84±0.01%. The said 3D printed precursor articles have a specific surface area of about 0.23±0.01 μm⁻¹, particularly preferably about 0.21±0.01 μm⁻¹ and most preferably about 0.19±0.01 μm⁻¹.

In an advantageous embodiment, the 3D printed precursor articles produced from the particulate material systems described above using a commercial binder jetting powder-based 3D printer preferably have a pore connectivity of about 99.72±0.04% and a specific surface area of about 0.20±0.01 μm⁻¹.

In order to assess mechanical properties of the 3D printed articles, standard square prisms (about 15 mm width×about 15 mm length×about 30 mm height) may be produced from the particulate material systems described above using a commercial binder jetting powder-based 3D printer and tested on a universal mechanical testing machine with a 30 kN load cell from Instron Pty. Ltd., USA. The longest side of the CAD models of the square prisms may preferably be aligned with the x-axis of the build platform in the respective software of the commercial binder jetting powder-based 3D printer to exclude the impact of building direction on the mechanical properties of the 3D printed articles. Each 3D printed square prism, referred to as specimen herein, may be subjected to a compression load along the axial direction at a constant cross-head loading rate of about 0.5 mm/min to evaluate engineering compressive stress-strain curves according to ASTM D695-15 and obtain the corresponding compressive mechanical parameters including compressive strength defined as the maximum compressive stress that the specimen can withstand before failure, compressive strain defined as the longitudinal strain at which the first failure occurs in the specimen, and compressive modulus defined as the slope of initial linear portion of engineering compressive stress-strain curves.

In order to draw a clear comparison between mechanical properties of the 3D printed articles produced from different particulate material systems described above, specific compressive strength, also known as compressive strength-to-weight ratio, and specific compressive modulus, also known as compressive stiffness-to-weight ratio, may also be calculated by dividing compressive strength and compressive modulus by the true density of the 3D printed articles, respectively.

In various embodiments, the 3D printed precursor articles produced from the particulate material systems described above using a commercial binder jetting powder-based 3D printer preferably have a compressive modulus of about 1.98±0.23 GPa, particularly preferably about 2.37±0.16 GPa and most preferably about 4.00±0.45 GPa. The said 3D printed precursor articles preferably have a specific compressive modulus of about 1.33±0.1 GPa/g.cm⁻³, particularly preferably about 1.59±0.15 GPa/g.cm⁻³ and most preferably about 2.62±0.27 GPa/g.cm⁻³.

In various embodiments, the 3D printed precursor articles produced from the particulate material systems described above using a commercial binder jetting powder-based 3D printer preferably have a compressive strength of about 0.26±0.02 MPa, particularly preferably about 0.35±0.03 MPa and most preferably about 0.47±0.02 MPa, indicating that the 3D printed precursor articles are stable enough to undergo thermal conversion into carbon preforms. The said 3D printed precursor articles preferably have a specific compressive strength of about 0.14±0.01 MPa/g.cm⁻³, particularly preferably about 0.17±0.01 MPa/g.cm⁻³ and most preferably about 0.32±0.03 MPa/g.cm⁻³.

In various embodiments, the 3D printed precursor articles produced from the particulate material systems described above using a commercial binder jetting powder-based 3D printer preferably have a compressive strain of about 1.36±0.19%, particularly preferably about 1.42±0.18% and most preferably about 1.89±0.24%.

In an advantageous embodiment, the 3D printed precursor articles produced from the particulate material systems described above using a commercial binder jetting powder-based 3D printer preferably have a compressive modulus of about 2.95±0.32 GPa, specific compressive modulus of about 1.97±0.21 GPa/g.cm⁻³, compressive strength of about 0.35±0.03 MPa, specific compressive strength of about 0.23±0.02 MPa/g.cm⁻³ and compressive strain of about 1.73±0.26%.

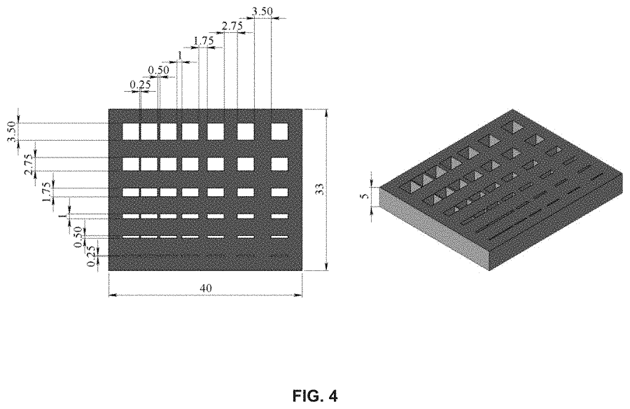

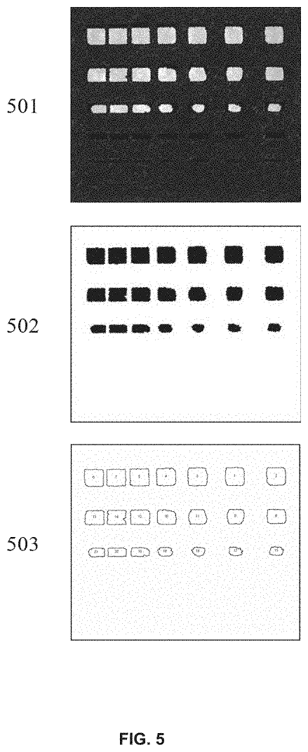

Generally speaking, minimum feature size of the 3D printed articles is defined either based on the x-y plane of the 3D printer's build platform known as spatial resolution or across the z-axis referred to as layer thickness. Within the scope of the present invention, the former definition may be used in order to assess the minimum feature size of the 3D printed articles for which standard test plates (40 mm length×33 mm width×5 mm in height) consisting of square-shaped holes with varying side dimensions between 0.25 mm to 3.5 mm as shown in FIG. 4 may be produced from the particulate material systems described above using a commercial binder jetting powder-based 3D printer. As shown in FIG. 5, each 3D printed standard test plate may be initially scanned by a digital two-dimensional (2D) scanner to collect a 2D image 501 of its up-facing surface for image processing analysis. The collected 2D image 501 of the 3D printed standard test plate may then be analyzed by a 2D image analysis software (Image) 1.49v, National Institutes of Health, USA) to measure the total area of square-shaped holes on the up-facing surface. The analysis may start with thresholding and converting the 2D image 501 into a binary 2D image 502 followed by labelling the holes in the binary 2D image 502 using a one-pixel wide outline to obtain a labelled 2D image 503. The labelled 2D image 503 may finally be used to measure the area of each labeled hole and calculate the total area of holes on each 2D image 501. The total area of holes may be considered as an indicative measure of the minimum feature size of each 3D printed standard test plate, meaning the larger the total area of holes, the smaller the minimum feature size.

In various embodiments, the 3D printed precursor articles produced from the particulate material systems described above using a commercial binder jetting powder-based 3D printer preferably have a total area of holes of about 13,038 pixels (equivalent to a hole size of about 2.75 mm and a minimum feature size of about 0.25 mm), particularly preferably about 25,889 pixels (equivalent to a hole size of about 1.75 mm and a minimum feature size of about 0.25 mm) and most preferably about 36,569 pixels (equivalent to a hole size of about 1 mm and a minimum feature size of about 0.25 mm).

In an advantageous embodiment, the 3D printed precursor articles produced from the particulate material systems described above using a commercial binder jetting powder-based 3D printer preferably have a total area of holes of about 32,976 pixels (equivalent to a hole size of about 1.75 mm and a minimum feature size of about 0.25 mm).

Generally speaking, dimensional accuracy is defined as the degree of agreement between the dimensions of the 3D printed article and its CAD model. Typically, the best achievable dimensional accuracy largely depends on material chemistry, fabrication regime, build orientation, post-processing operations, geometric features, topology and nominal dimensions, to name a few. In binder jetting powder-based 3D printing technology, powder compressibility during 3D printing process can substantially affect the dimensional accuracy of the 3D printed articles due to potential powder layer displacements across the z-axis of the build platform (powder compressibility refers to the ability of the particulate material system to decrease in volume under pressure). In order to assess the dimensional accuracy of the 3D printed articles, standard square prisms (15 mm width×15 mm length×30 mm height) may be produced from the particulate material systems described above using a commercial binder jetting powder-based 3D printer. The dimensions of each 3D printed square prism, referred to as specimen herein, are measured using a digital caliper to calculate the dimensional variations (DV) using Equation 3, where d_{cad} and d_{specimen} refer to the dimensions of the CAD model and the 3D printed specimen, respectively. The dimensional accuracy of the 3D printed specimen may be reported in terms of the variation of length across the x-axis (Length (X)), width across the y-axis (Width (Y)), width across the z-axis (Width (Z)) and bulk volume.

$$D V = \frac{{d}_{specimen} - {d}_{cad}}{{d}_{cad}} \qquad ( 3 )$$

In an advantageous embodiment, the dimensions of the 3D printed precursor articles produced from the particulate material systems described above using a commercial binder jetting powder-based 3D printer linearly deviated from the initial dimensions of the CAD model by about −1.74±0.20% across the x-axis (Length (X)), about −1.21±0.22% across the y-axis (Width (Y)) and about −1.40±0.26% across the z-axis (Width (Z)). Also, the dimensions of the said 3D printed precursor articles volumetrically deviated from the initial dimensions of the CAD model by about −4.29±0.26%. This highlights the need for a dimensional correction factor that may be applied in the software of the commercial binder jetting powder-based 3D printer to account for the discrepancies in the dimensions and bulk volume of the 3D printed precursor articles.

### Step 3—Intermediate Impregnation of 3D Printed Precursor Articles

Referring to FIG. 1, an intermediate impregnation 103 may optionally be used to increase the density of the 3D printed precursor articles using a dilute polymer solution or an impregnant by filling out inter-particle void spaces and increasing particle connectivity across the microstructure. The 3D printed precursor articles need to have sufficient strength to allow for the intermediate impregnation 103. Depending on the type of polymer, impregnant or their substitutes, the optional intermediate impregnation 103 may yield 3D printed articles with greater strength, durability and water-proof properties.

The optional intermediate impregnation 103 may be conducted using a group of materials consisting of cellulose acetate (CA), cellulose acetate butyrate (CAB) and cellulose acetate propionate (CAP) which are soluble in organic solvents. The organic solvent may be selected from a group of materials consisting of acetone, methanol, ethanol, isopropanol and n-propanol. Other polymers, materials, chemicals or impregnates and combinations thereof may also be used in some variations of the optional intermediate impregnation 103 depending on the type of the carbon precursor material (a) and adhesive material (b) used in the preparation of the preferred particulate material systems according to the present invention.

In advantageous embodiments, a dilute solution of CA with an average molecular weight of about 50,000 g/mol in acetone may be used in the intermediate impregnation of the 3D printed precursor articles according to the present invention. Through a series of trial and error experiments, an about 10 wt.% CA solution in acetone is found dilute enough to easily penetrate the microstructure of the 3D printed precursor articles. In an advantageous embodiment, the 3D printed precursor articles are first vacuum dried at about 80° C. for about 24 h and then immediately submerged in the preferred CA solution in acetone for about 30 min in an enclosed container at room temperature. Subsequently, the CA impregnated 3D printed precursor articles are taken out and thoroughly wiped by a paper towel to clean any excess solution remaining on the surface. Finally, all the CA impregnated 3D printed articles are left on a non-stick substrate under the fume hood to dry at room temperature overnight.

In an advantageous embodiment, the CA impregnated 3D printed precursor articles according to the present invention preferably have a true density of about 1.48±0.01 g/cm³, apparent porosity of about 65.47±0.51%, pore connectivity of about 99.66±0.07%, specific surface area of about 0.19±0.01 μm⁻¹, compressive modulus of about 14.67±0.91 GPa, specific compressive modulus of about 9.92±1.29 GPa/g.cm⁻³, compressive strength of about 2.79±0.26 MPa, specific compressive strength of about 1.88±0.17 MPa/g.cm⁻³ and compressive strain of about 5.72±0.43%. As a result of CA impregnation, there may be an overall increase of about 40% in the deviation of the dimensions and bulk volume of the CA impregnated 3D printed precursor articles from those of the CAD model. This may be due to the penetration of CA polymer chains into the porous structure of the 3D printed precursor article during intermediate impregnation which has ultimately led to a linear dimensional shrinkage upon evaporation of acetone at room temperature. This highlights the need for a dimensional correction factor that may be applied in the initial CAD model to account for the discrepancies in the dimensions and bulk volume of the CA impregnated 3D printed precursor articles.

In some variations, the optional intermediate impregnation may be integrated into the binder jetting powder-based 3D printing process. This may be conducted by applying a liquid binder made of the same polymer, impregnant or their substitutes used in the optional intermediate impregnation. This may be practiced using a binder jetting powder-based 3D printer equipped with piezoelectric ink-jet print head(s) that can deposit the above-mentioned liquid binder on the powder bed. As such, the adhesive material (b) may be removed from the preferred particulate material system due to the use of this special type of liquid binder, leading to an increase in the content of the carbon precursor material (a) in the particulate material system and ultimately yielding 3D printed articles with improved strength, durability and water-proof properties.

Step 4—Thermal Conversion of 3D Printed Precursor Articles into Carbon Preforms

Referring to FIG. 1, thermal conversion of the 3D printed precursor articles (impregnated or not-impregnated with CA) into carbon preforms is conducted through a two-stage consecutive heat-treatment processes of stabilization 104 and carbonization 105.

The term ‘stabilization’ refers to a thermal conversion process in air, preferably oxygen, where the 3D printed precursor articles (impregnated or not-impregnated with CA) are oxidized by heating to a temperature of preferably at least about 240° C. at a heating rate of preferably at least about 1° C./min. In some embodiments, depending on the composition of the particulate material system used to produce the 3D printed precursor articles (impregnated or not-impregnated with CA), stabilization may be conducted at a temperature between about 240° C. and about 280° C. and a heating rate between about 0.5° C./min and about 2° C./min.

The term ‘carbonization’ refers to a thermal conversion process in an inert atmosphere, preferably nitrogen or argon, where the stabilized 3D printed precursor articles (impregnated or not-impregnated with CA) are converted into carbon preforms or carbon containing preforms by heating to a temperature of preferably at least about 800° C. at a heating rate of preferably at least about 2° C./min. In some embodiments, depending on the composition of the particulate material system used to produce the 3D printed precursor articles (impregnated or not-impregnated with CA), carbonization may be conducted at a temperature between about 800° C. and about 1400° C. and a heating rate between about 1° C./min and 2° C./min.

The time required for the two-stage consecutive heat-treatment process of stabilization 104 and carbonization 105 is variable depending on the composition of the particulate material system used to produce the 3D printed precursor articles (impregnated or not-impregnated with CA). Also, the size and shape of the 3D printed precursor articles (impregnated or not-impregnated with CA) play a part in determining the resident time at stabilization and carbonization temperatures. In various embodiments, it is preferable that the 3D printed precursor articles (impregnated or not-impregnated with CA) are held at least for about 1 to 2 hours at stabilization and carbonization temperatures to produce carbon preforms with a highly crystalline carbonaceous structure and good mechanical properties. Once the two-stage consecutive heat-treatment processes of stabilization 104 and carbonization 105 is completed, it is preferable that the resultant carbon preforms are naturally cooled down to room temperature before being removed from the furnace.

In various embodiments, a secondary carbonization 106 preferably in a vacuum furnace partially purged with argon or nitrogen may be conducted to further enhance the crystalline carbonaceous structure of the carbon preforms by heating to a temperature of preferably at least about 1500° C. at a heating rate of preferably at least about 10° C./min and with a resident time of at least about 4 h. In some embodiments, depending on the composition of the particulate material system used to produce the 3D printed precursor articles (impregnated or not-impregnated with CA), the secondary carbonization may be conducted at a temperature between about 1500° C. and about 1900° C. and a heating rate between about 5° C./min and about 10° C./min and a resident time of at least about 4 h.

In various embodiments, carbon preforms produced from the 3D printed precursor articles (not-impregnated with CA) through the two-stage consecutive heat-treatment processes of stabilization 104 and carbonization 105 according to the present invention preferably have a true density of about 1.04±0.03 g/cm³, particularly preferably about 1.34±0.06 g/cm³ and most preferably about 1.42±0.05 g/cm³. The said carbon preforms preferably have an apparent porosity of about 74.22±0.73%, particularly preferably about 71.58±0.62% and most preferably about 69.30±0.73%.

In an advantageous embodiment, carbon preforms produced from the 3D printed precursor articles (not-impregnated with CA) through the two-stage consecutive heat-treatment processes of stabilization 104 and carbonization 105 according to the present invention preferably have a true density of about 1.44±0.03 g/cm³. The said carbon preforms preferably have an apparent porosity of about 70.58±0.91%.

In another advantageous embodiment, carbon preforms produced from the 3D printed precursor articles (not-impregnated with CA) through the two-stage consecutive heat-treatment processes of stabilization 104 and carbonization 105 followed by the secondary carbonization 106 according to the present invention preferably have a true density of about 1.36±0.02 g/cm³. The said carbon preforms preferably have an apparent porosity of about 70.31±0.56%.

In another advantageous embodiment, carbon preforms produced from the 3D printed precursor articles (impregnated with CA) through the two-stage consecutive heat-treatment processes of stabilization 104) and carbonization 105 followed by the secondary carbonization 106 according to the present invention preferably have a true density of about 1.38±0.01 g/cm³. The said carbon preforms preferably have an apparent porosity of about 71.04±0.02%.

In various embodiments, carbon preforms produced from the 3D printed precursor articles (not-impregnated with CA) through the two-stage consecutive heat-treatment processes of stabilization 104 and carbonization 105 according to the present invention preferably have a pore connectivity of about 99.96±0.01%, particularly preferably about 99.98±0.01% and most preferably about 99.99±0.01%. The said carbon preforms preferably have a specific surface area of about 0.26±0.01 μm⁻¹, particularly preferably about 0.24±0.01 μm⁻¹ and most preferably about 0.20±0.01 μm⁻¹.

In an advantageous embodiment, carbon preforms produced from the 3D printed precursor articles (not-impregnated with CA) through the two-stage consecutive heat-treatment processes of stabilization 104 and carbonization 105 according to the present invention preferably have a pore connectivity of about 99.97±0.01%. The said carbon preforms preferably have a specific surface area of about 0.21±0.01 μm⁻¹.

In another advantageous embodiment, carbon preforms produced from the 3D printed precursor articles (not-impregnated with CA) through the two-stage consecutive heat-treatment processes of stabilization 104 and carbonization 105 followed by the secondary carbonization 106 according to the present invention preferably have a pore connectivity of about 99.99±0.01%. The said carbon preforms preferably have a specific surface area of about 0.23±0.01 μm⁻¹.

In another advantageous embodiment, carbon preforms produced from the 3D printed precursor articles (impregnated with CA) through the two-stage consecutive heat-treatment processes of stabilization 104) and carbonization 105 followed by the secondary carbonization 106 according to the present invention preferably have a pore connectivity of about 99.98±0.01%. The said carbon preforms preferably have a specific surface area of about 0.23±0.01 μm⁻¹.

In various embodiments, carbon preforms produced from the 3D printed precursor articles (not-impregnated with CA) through the two-stage consecutive heat-treatment processes of stabilization 104 and carbonization 105 according to the present invention preferably have a compressive modulus of about 8.26±0.78 GPa, particularly preferably about 11.30±0.87 GPa and most preferably about 17.59±0.97 GPa. The said carbon preforms preferably have a specific compressive modulus of about 4.87±0.28 GPa/g.cm⁻³, particularly preferably about 7.41±0.26 GPa/g.cm⁻³ and most preferably about 11.83±0.34 GPa/g.cm⁻³.

In various embodiments, carbon preforms produced from the 3D printed precursor articles (not-impregnated with CA) through the two-stage consecutive heat-treatment processes of stabilization 104 and carbonization 105 according to the present invention preferably have a compressive strength of about 1.46±0.06 MPa, particularly preferably about 1.88±0.08 MPa and most preferably about 3.43±0.10 MPa. The said carbon preforms preferably have a specific compressive strength of about 1.21±0.07 MPa/g.cm⁻³, particularly preferably about 1.35±0.10 MPa/g.cm⁻³ and most preferably about 2.56±0.09 MPa/g.cm⁻³.

In various embodiments, carbon preforms produced from the 3D printed precursor articles (not-impregnated with CA) through the two-stage consecutive heat-treatment processes of stabilization 104 and carbonization 105 according to the present invention preferably have a compressive strain of about 1.95±0.08%, particularly preferably about 2.46±0.11% and most preferably about 2.95±0.23%.

In an advantageous embodiment, carbon preforms produced from the 3D printed precursor articles (not-impregnated with CA) through the two-stage consecutive heat-treatment processes of stabilization 104 and carbonization 105 according to the present invention preferably have a compressive modulus of about 7.29±3.90 GPa, specific compressive modulus of about 5.08±2.70 GPa/g.cm⁻³, compressive strength of about 3.12±0.30 MPa, specific compressive strength of about 2.18±0.27 MPa/g.cm⁻³ and compressive strain of about 6.14±0.65%.

In another advantageous embodiment, carbon preforms produced from the 3D printed precursor articles (not-impregnated with CA) through the two-stage consecutive heat-treatment processes of stabilization 104 and carbonization 105 followed by the secondary carbonization 106 according to the present invention preferably have a compressive modulus of about 18.67±2.17 GPa, specific compressive modulus of about 13.69±2.02 GPa/g.cm⁻³, compressive strength of about 3.13±0.28 MPa, specific compressive strength of about 2.30±0.21 MPa/g.cm⁻³ and compressive strain of about 8.07±0.47%.

In another advantageous embodiment, carbon preforms produced from the 3D printed precursor articles (impregnated with CA) through the two-stage consecutive heat-treatment processes of stabilization 104 and carbonization 105 followed by the secondary carbonization 106 according to the present invention preferably have a compressive modulus of about 30.42±2.22 GPa, specific compressive modulus of about 22.18±2.05 GPa/g.cm⁻³, compressive strength of about 6.43±0.49 MPa, specific compressive strength of about 4.69±0.36 MPa/g.cm⁻³ and compressive strain of about 7.02±0.44%.

In an advantageous embodiment, the carbon preforms produced from the 3D printed precursor articles (impregnated with CA) through the two-stage consecutive heat-treatment processes of stabilization 104 and carbonization 105 followed by the secondary carbonization 106 according to the present invention preferably have a favorable thermal stability upon exposure to a direct oxy-acetylene gas flame with a flame temperature of around 3480° C.

In many embodiments, the dimensions of carbon preforms produced from the 3D printed precursor articles (impregnated or not-impregnated with CA) through the two-stage consecutive heat-treatment processes of stabilization 104 and carbonization 105, which may or may not be followed by the secondary carbonization 106 according to the present invention, volumetrically deviated from the initial dimensions of the CAD model by about -71.87±0.49% to about −67.99±0.59%. Also, the dimensions of the said carbon preforms linearly deviated from the initial dimensions of the CAD model by about −33.81±0.22% to about −31.81±0.41% across the x-axis (Length (X)), about −34.01±0.52% to about −31.70±0.57% across the y-axis (Width (Y)) and about −35.60±0.74% to about −31.27±0.71% across the z-axis (Width (Z)), indicating a relatively isotropic shrinkage of the 3D printed precursor articles (impregnated or not-impregnated with CA) during thermal conversion.

### Steps 5 & 6—Resin Infiltration of Carbon Preforms

Referring to FIG. 1, resin infiltration of carbon preforms produced from the 3D printed precursor articles (impregnated or not-impregnated with CA) through the two-stage consecutive heat-treatment processes of stabilization 104 and carbonization 105, which may or may not be followed by the secondary carbonization 106, is conducted by means of capillary action under atmospheric condition 107 according to the present invention. In some variations, vacuum or pressure in an enclosed sealed chamber or container may also be used for resin infiltration of the said carbon preforms.

The preferred resin system according to the present invention is preferably a low-viscosity, low-outgassing and room temperature curing epoxy resin with two individual components, which are to be mixed at a recommended weight ratio prior to resin infiltration of carbon preforms by means of capillary action under atmospheric condition 107. One typical example of such preferred two-component epoxy resin system according to the present invention is EPO-TEK® 301 (Epoxy Technology Inc., USA) with a viscosity of about 100 to about 200 cPs @ 100 rpm at 23° C. and a recommended weight ratio of 20:5 (Part A to Part B), given Part A and Part B have a specific gravity of 1.15 and 0.87, respectively. In some variations, the preferred epoxy resin system may be used for resin infiltration of carbon preforms under vacuum or pressure in an enclosed sealed chamber or container. The epoxy resin system may be selected based on the target application and performance of the resultant carbon composite articles.

In some variations, where vacuum or pressure in an enclosed sealed chamber or container may be preferred for resin infiltration of carbon preforms, other classes of resin systems such as acrylics, polyesters, polyurethanes, silicones or phenols as well as preceramic polymers may be selected depending on the target application and performance of the resultant carbon composite articles.

In many embodiments, first the two components are separately weighed into a container according to the recommended weight ratio of 20:5 (Part A/Part B). The two components are then mixed and stirred in clockwise and counter-clockwise fashion for about 3 min to obtain a homogeneous epoxy resin mixture. Following that, carbon preforms in the form of a standard square prism (about 10 mm width×about 10 mm length×about 20 mm height), which are already vacuum dried at about 80° C. for about 24 h, are immediately submerged in the as-prepared epoxy resin mixture under atmospheric condition for about 45 min. The time required to complete infiltration process depends on the size and dimensions of carbon preforms. The bigger the size of the carbon preforms, the longer it takes to complete the infiltration process. Next, the epoxy resin infiltrated carbon preforms are taken out and thoroughly wiped by a paper towel to clean any excessive epoxy resin left on the surface. Finally, the epoxy resin infiltrated carbon preforms are left on a non-stick surface under the fume hood to cure at room temperature overnight. Referring to FIG. 1, the 3D printed carbon composite articles are produced upon curing the epoxy resin infiltrated carbon preforms at room temperature 108 or at a curing temperature depending on the class of resin used during resin infiltration.

In some variations, a vacuum bagging system may be used for infiltration of the carbon preforms produced from the 3D printed precursor articles (impregnated or not-impregnated with CA) through the two-stage consecutive heat-treatment processes of stabilization 104 and carbonization 105, which may or may not be followed by the secondary carbonization 106. As such, the carbon preforms may be wrapped by a vacuum bagging film and sealed by a sealant tape. The said vacuum bagging system typically has an inlet connected to a reservoir containing a low-viscosity liquid-based material(s) and an outlet connected to a vacuum pump to allow for infiltration of the carbon preforms. The low-viscosity liquid-based material(s) is then infused through the inlet into the vacuum bagging system by the vacuum pump to infiltrate the carbon preforms and cure or polymerize at room temperature or at a temperature depending on the class of the low-viscosity liquid-based material(s). The time required to complete infiltration process of the carbon preforms in the vacuum bagging system depends on the size and dimensions of the carbon preforms as well as the class of the low-viscosity liquid-based material(s). Finally, the vacuum bagging film is removed at room temperature after completion of curing or polymerization. Depending on the target application and performance of the resultant carbon composite articles, the low-viscosity liquid-based material(s) may be selected from a group of materials such as epoxies, acrylics, polyesters, polyurethanes, silicones, phenols and preceramic polymers or combinations thereof.

In various embodiments, the 3D printed carbon composite articles produced through resin infiltration of carbon preforms by means of capillary action under atmospheric condition 107 according to the present invention, which may or may not have involved optional intermediate impregnation 103 of the initial 3D printed precursor articles with CA and/or secondary carbonization 106 of carbon preforms as described in the previous sections, preferably have a true density of about 1.24±0.01 g/cm³, particularly preferably about 1.22±0.04 g/cm³ and most preferably about 1.14±0.01 g/cm³. The said 3D printed carbon composite articles preferably have an apparent porosity of about 11.51 ±0.63%, particularly preferably about 9.65±0.83% and most preferably about 7.62±0.73%.

In an advantageous embodiment, the 3D printed carbon composite articles produced through resin infiltration of carbon preforms by means of capillary action under atmospheric condition 107 according to the present invention, which have involved optional intermediate impregnation 103 of the initial 3D printed precursor articles with CA as well as secondary carbonization 106 of carbon preforms as described in the previous sections, preferably have a true density of about 1.10±0.01 g/cm³. The said 3D printed carbon composite articles preferably have an apparent porosity of about 7.69±0.63%. In some variations, the apparent porosity of the said 3D printed carbon composite articles may be reduced to as low as zero percent by conducting resin infiltration of carbon preforms under vacuum or pressure in an enclosed sealed chamber or container. Other classes of resin systems such as acrylics, polyesters, polyurethanes, silicones or phenols may be preferred in some variations to account for the residual porosity in the resultant 3D printed carbon composite articles.

In various embodiments, the 3D printed carbon composite articles produced through resin infiltration of carbon preforms by means of capillary action under atmospheric condition 107 according to the present invention, which may or may not have involved optional intermediate impregnation 103 of the initial 3D printed precursor articles with CA and/or secondary carbonization 106 of carbon preforms as described in the previous sections, preferably have a compressive modulus of about 179.02±10.77 GPa, particularly preferably about 201.13±9.83 GPa and most preferably about 211.31±18.24 GPa. The said 3D printed carbon composite articles preferably have a specific compressive modulus of about 147.04±8.67 GPa/g.cm⁻³, particularly preferably about 162.84±14.44 GPa/g.cm⁻³ and most preferably about 185.47±12.01 GPa/g.cm⁻³.

In various embodiments, the 3D printed carbon composite articles produced through resin infiltration of carbon preforms by means of capillary action under atmospheric condition 107 according to the present invention, which may or may not have involved optional intermediate impregnation 103 of the initial 3D printed precursor articles with CA and/or secondary carbonization 106 of carbon preforms as described in the previous sections, preferably have a compressive strength of about 73.87±5.62 MPa, particularly preferably about 79.88±4.84 MPa and most preferably about 84.26±3.29 MPa. The said 3D printed carbon composite articles preferably have a specific compressive strength of about 59.81±4.55 MPa/g.cm⁻³, particularly preferably about 66.22±4.45 MPa/g.cm⁻³ and most preferably about 73.78±2.88 MPa/g.cm⁻³.

In various embodiments, the 3D printed carbon composite articles produced through resin infiltration of carbon preforms by means of capillary action under atmospheric condition 107 according to the present invention, which may or may not have involved optional intermediate impregnation 103 of the initial 3D printed precursor articles with CA and/or secondary carbonization 106 of carbon preforms as described in the previous sections, preferably have a compressive strain of about 7.98±0.61%, particularly preferably about 8.88±0.57% and most preferably about 10.05±0.35%.

In an advantageous embodiment, the 3D printed carbon composite articles produced through resin infiltration of carbon preforms by means of capillary action under atmospheric condition 107 according to the present invention, which have involved optional intermediate impregnation 103 of the initial 3D printed precursor articles with CA as well as secondary carbonization 106 of carbon preforms as described in the previous sections, preferably have a compressive modulus of about 233±8.37 GPa, specific compressive modulus of about 211.05±15.32 GPa/g.cm⁻³, compressive strength of about 78.96±6.23 MPa, specific compressive strength of about 71.52±4.65 MPa/g.cm⁻³ and compressive strain of about 7.76±0.63%.

In many embodiments, the dimensions of the 3D printed carbon composite articles produced through resin infiltration of carbon preforms by means of capillary action under atmospheric condition 107 according to the present invention, which may or may not have involved optional intermediate impregnation 103 of the initial 3D printed precursor articles with CA and/or secondary carbonization 106 of carbon preforms as described in the previous sections, volumetrically deviated from the initial dimensions of the CAD model by about −72.45±0.54% to about −68.46±0.36%. Also, the dimensions of the said carbon composite articles linearly deviated from the initial dimensions of the CAD model by about −34.61±0.48% to about −32.56±0.27% across the x-axis (Length (X)), about −34.15±0.28% to about −31.93±0.33% across the y-axis (Width (Y)) and about −36.01±0.78% to about −30.89±0.71% across the z-axis (Width (Z)). The initial CAD model of the articles may be scaled by about 1.38 to about 1.46 to account for these relatively isotropic dimensional variations in the resultant carbon composite articles.

The 3D printed carbon composite articles produced according to the present invention outperform plastics, metals/alloys, technical ceramics as well as mostly known composite materials such as carbon fiber reinforced composites or plastics. It is envisioned that the present invention would open new doors towards manufacturing high-performance functional carbon composite articles with complex geometries and high-end applications ranging from thermal protection systems, porous burners, heat and electrical conductors, gas sensors, battery electrodes, sound and impact absorption, electromagnetic interference shielding, to bone tissue engineering, load-bearing orthopedic implants, bone fixation screws and segmental bone defects reconstruction.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

1-67. canceled

68. A method for manufacturing a carbon composite article by binder jetting powder-based 3D printing technology comprising steps of:
preparing a particulate material system;
introducing the particulate material system into the binder jetting powder-based 3D printer and producing a precursor article;
converting the precursor article into a carbon preform;
infiltrating the carbon preform with a low-viscosity liquid-based material; and
curing or polymerizing the infiltrated carbon preform to form the carbon composite article.

69. A method according to claim 68, wherein the particulate material system comprises:
(a) about 2.38 to about 3.14 parts by weight of a carbon precursor material;
(b) about zero to about 2.38 parts by weight of an adhesive material; and
(c) about zero to about 0.24 parts by weight of a capillary action retarder.

70. A method according to claim 68, wherein the precursor article is produced by introducing the particulate material system into the binder jetting powder-based 3D printer with successive applications of the particulate material system and a liquid binder.

71. A method according to claim 68, wherein the precursor article is converted into a carbon preform through a two-stage consecutive heat-treatment processes of stabilization and carbonization.

72. A method according to claim 68, wherein the low viscosity liquid based material is a resin, monomer, oligomer, polymer, pre-polymer or mixtures thereof selected from a group of materials such as epoxies, acrylics, polyesters, polyurethanes, silicones, phenols and preceramic polymers.

73. A method according to claim 68, wherein the infiltrated carbon preform is cured or polymerized at room temperature or at a temperature depending on the class of material(s) used for infiltration purposes.

74. A method according to claim 69, wherein the carbon precursor material is selected from a group of renewable materials consisting of naturally occurring biopolymers including polysaccharides (e.g. cellulose & hemicellulose) and proteins (e.g. silk & wool) as well as naturally occurring phenolic compounds including lignin and its derivatives.

75. A method according to claim 69, wherein the adhesive material is selected from a group of water-soluble materials consisting of low-molecular-weight polysaccharides such as dextrin, maltodextrin, dextran, starch, sucrose and glucose.

76. A method according to claim 69, wherein the capillary action retarder is selected from a group of cellulose derivatives consisting of hydroxypropyl methylcellulose, hydroxypropyl cellulose, hydroxyethyl cellulose, methyl cellulose and sodium carboxymethyl cellulose.

77. A method according to claim 69, wherein the particulate material system comprises:
a. about 0.86 parts by weight of cellulose powder with a D₅₀ of about 60 μm;
b. about 1.52 parts by weight of cellulose powder with a D₅₀ of about 18 μm;
c. about 2.38 parts by weight of dextrin powder with a D₅₀ of about 39 μm; and
d. about 0.24 parts by weight of hydroxypropyl methylcellulose powder with a D₅₀ of about 87 μm.

78. A method according to claim 69, wherein the particulate material system is composed of both irregular and regular particles with a particle size distribution exhibiting a D₁₀ of about 10 μm, D₅₀ of about 35 μm and D₉₀ of about 110 μm.

79. A method according to claim 70, wherein the liquid binder is selected from a group of materials consisting of water, glycerol, methyl alcohol, isopropyl alcohol, polyvinyl pyrrolidone, polyvinyl alcohol.

80. A method according to claim 70, wherein the liquid binder is VisiJet® PXL Clear (3D Systems Inc., USA).

81. A method according to claim 70, wherein the binder jetting powder-based 3D printer fabricates the precursor article at a layer thickness between about 165 μm and about 185 μm and a liquid binder saturation level between about 52% and about 100%.

82. A method according to claim 70, wherein the binder jetting powder-based 3D printer is optimized to produce the precursor article at a layer thickness of about 181 μm and a saturation level of about 73%.

83. A method according to claim 70, wherein, following production, the 3D printed precursor article is left in a powder bed for at least about 24 hours at room temperature.

84. A method according to claim 68, further comprising a step of intermediate impregnation of the 3D printed precursor article using an about 10 wt.% cellulose acetate (CA) solution in acetone.

85. A method according to claim 84, wherein the CA solution has an average molecular weight of about 50,000 g/mol.

86. A method according to claim 84, wherein the 3D printed precursor article is first vacuum dried at about 80° C. for about 24 h prior to impregnating with the CA solution in acetone for about 30 min in an enclosed container at room temperature.

87. A method according to claim 84, wherein the CA impregnated precursor article is left on a non-stick substrate under the fume hood to dry at room temperature overnight.
